(19) United States
(12) Patent Application Publication
(10) Pub. No.: US 2012/0146876 A1
(43) Pub. Date: Jun. 14, 2012

(54) SURFACE MOUNT DEVICE ANTENNA MODULE

(75) Inventor: Tsai-Yi YANG, Tainan City (TW)

(73) Assignee: Cirocomm Technology Corp.

(21) Appl. No.: 13/316,416

(22) Filed: Dec. 9, 2011

(30) Foreign Application Priority Data
Dec. 9, 2010 (TW) 099143120
Mar. 16, 2011 (TW) 100108918

(51) Int. Cl. H01Q 1/48; H01Q 1/12

(52) U.S. Cl. 343/848

(57) ABSTRACT

A surface mount device antenna module includes an antenna unit, a connecting unit and a circuit board. The connecting unit is used to connect the antenna unit and the circuit board. The antenna unit has a signal feeder electrically connected with the circuit board which is under the antenna unit. The antenna module is able to be attached onto the main board of an electronic device by surface mount technology. The area of the main board covered by the antenna module can be decreased. And the dimensions of the main board and the electronic device can be consequently decreased.

### BACKGROUND OF THE INVENTION

1. Field of the Invention

The present invention relates to an antenna, in particularly to a surface mount device antenna module.

2. Description of Related Art

Most of communication signals are transmitted through cables or atmosphere. When they are transmitted through atmosphere, antennas are needed to transmit and receive the communication signals.

In principle, antennas have similar ways to operate. Emitter antenna has a conductor generating electromagnetic wave from alternative electrical current. Such a generating process is like the wavelets on the water surface when dropping a pebble into the water. The propagating direction of the electromagnetic wave is omnidirectional. At a distance, another conductor of receiver antenna generates small amount of electrical current from received electromagnetic wave. Then, an amplifier can be used to magnify the amplitude of the electromagnetic wave for further usage.

FIGS. 1A & 1B show an available antenna module in the market for using on the electronic communication devices. The antenna module includes an antenna unit 1A, a connecting unit 2A, a cover 3A and a circuit board 4A. The antenna unit 1A connects with the cover 3A and the circuit board 4A through the connecting unit 2A, and a signal feeding connector 11A of the antenna unit 1A electrically connects with the circuit board 4A. The cover 3A and the circuit board 4A are perpendicular to the antenna unit 1A. The circuit board 4A of the antenna module is electrically connected to the main board 51A of the electronic communication devices 5A. The antenna unit 1A is arranged in the recess of the main board 51A.

Since the antenna unit 1A of the antenna module is vertically and electrically connected to the cover 3A and the circuit board 4A, the overall length of the antenna module is longer and its dimensions are larger. Since the antenna module is electrically connected to the main board 51A, a significant area of the main board 51A is covered by the antenna module. Thus, for arranging more electronic parts, the overall dimensions of the main board 51A need to be increased. However, as the dimensions of the main board 51 are increased, the dimensions of the electronic communication devices 5A are consequently increased.

### SUMMARY OF THE INVENTION

The main objective of the present invention is to provide a antenna module having reduced length and dimensions, which can be electrically connected to the main boards of the electronic communication devices. Thus the dimensions of the main board can be decreased, and the dimensions of the main board and the electronic communication devices can both be decreased.

For achieving the above-mentioned objective, the present invention provides a surface mount device antenna module for electrically connecting to the surface of a main board of an electronic device. The antenna module includes an antenna unit, a connecting unit and a circuit board. The antenna unit has a base, a radiating metal plate arranged on the top surface of the base, a grounding metal plate arranged on the bottom surface of the base and a signal feeder. A tunnel is formed through the base and the radiating metal plate. A hole is formed on the grounding metal plate and connects with the tunnel. The signal feeder is inserted into the tunnel and the hole. The signal feeder has a bottom end exposing out of the hole. The connecting unit has a top wall electrically connecting with the grounding metal plate and a plurality of side walls vertically extending downward from the edges of the top wall. An opening is formed on the top wall for passing though the bottom end of the signal feeder. The protrusions extend from the side walls. The circuit board has a connecting hole portion which has a first electric contact disposed on the top or bottom surface of the circuit board. The bottom end of the signal feeder is inserted into the connecting hole portion and electrically connects with the first electric contact. At least one second electric contact is arranged on the bottom surface of the circuit board.

### BRIEF DESCRIPTION OF THE DRAWINGS

FIG. 1A is schematic view of a conventional antenna module;

FIG. 1B is another schematic view of the conventional antenna module;

FIG. 2 is a perspective view of the antenna module of the present invention;

FIG. 3 is an exploded view of the antenna module of the present invention;

FIG. 4 is another exploded view of the antenna module of the present invention;

FIG. 5A is a circuit block diagram of the circuit board of the present invention;

FIG. 5B is another circuit block diagram of the circuit board of the present invention;

FIG. 6 is a schematic view showing the antenna module connected with a main board of an electronic device; and

FIG. 7 is a side schematic view showing the antenna module connected with a main board of an electronic device.

FIG. 8 is a schematic view of another surface mount device antenna module;

FIG. 9 is a sectional view of another surface mount device antenna module;

FIG. 10 is a schematic view of another surface mount device antenna module;

FIG. 11 is a sectional view of another surface mount device antenna module;

FIG. 12 is a schematic view of another surface mount device antenna module;

FIG. 13 is a sectional view of another surface mount device antenna module;

FIG. 14A is a block diagram of another circuit board in this invention;

FIG. 14B is a block diagram of another circuit board in this invention; and

FIG. 14C is a block diagram of another circuit board in this invention.

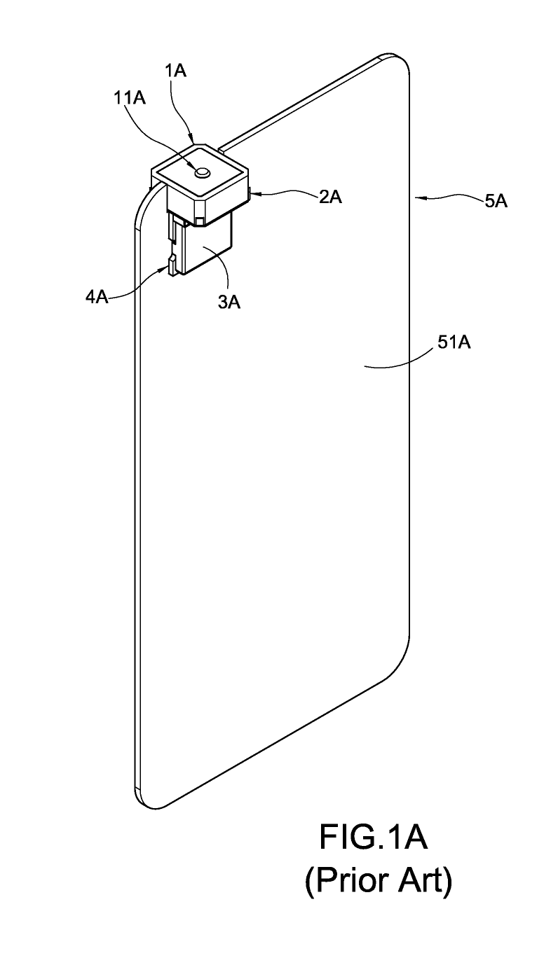

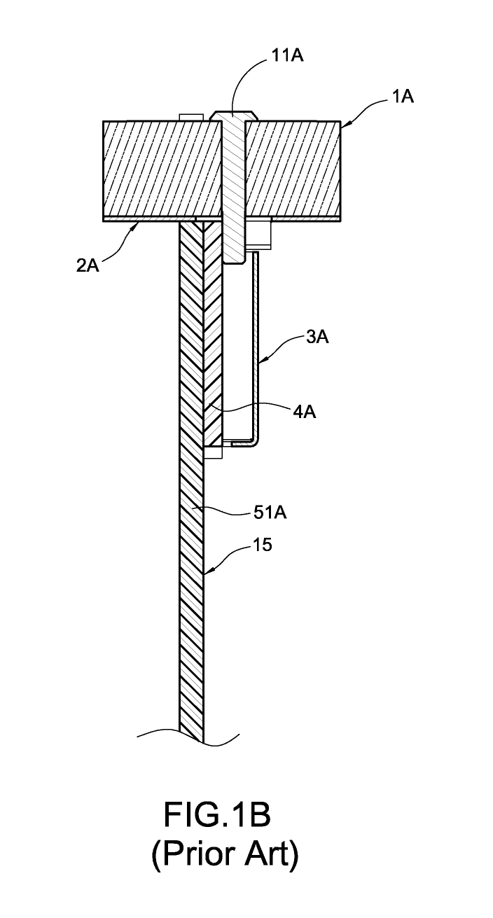

### DETAILED DESCRIPTION OF THE INVENTION

The technical characteristics and contents of the present invention will become apparent with the following detailed description accompanied with related drawings.

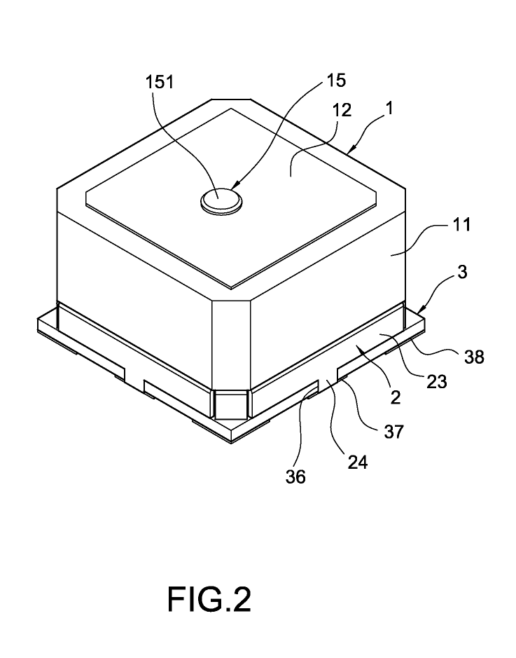

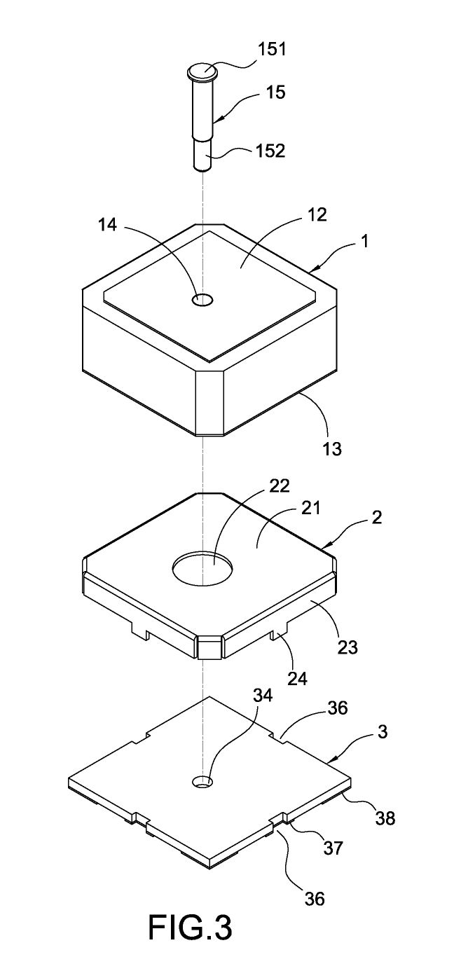

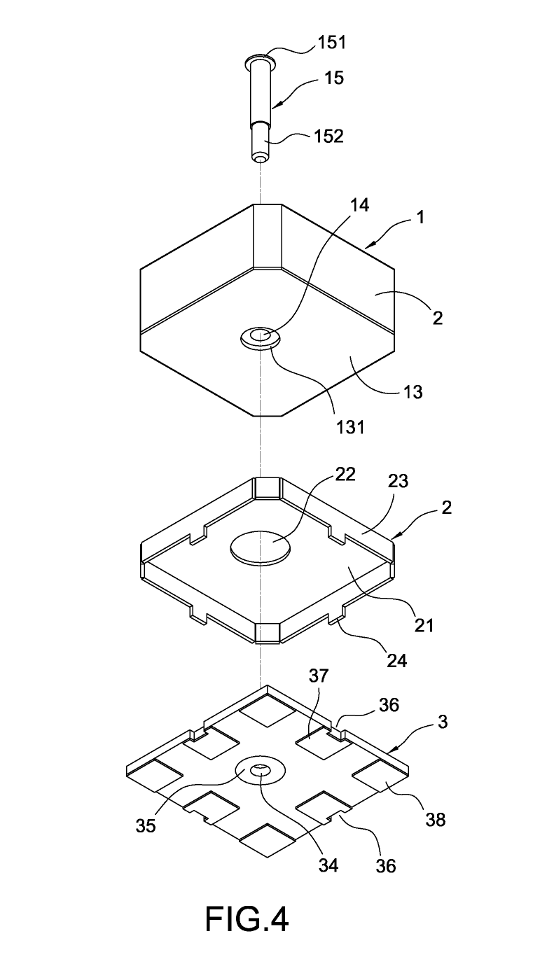

FIGS. 2 to 4 show a antenna module according to an embodiment of the present invention. The antenna module includes an antenna unit 1, a connecting unit 2 and a circuit board 3.

The antenna unit 1 has a base 11, a radiating metal plate 12 arranged on the top surface of the base 11, a grounding metal plate 13 arranged on the bottom surface of the base 11 and a signal feeder 15. The base 11 is a rectangular shaped plate made of ceramic material. A tunnel 14 is formed through the base 11 and the radiating metal plate 12. A hole 131 is formed on the grounding metal plate 13 and connects with the tunnel 14. The signal feeder 15 is of T-shape and is used for feeding signals. The signal feeder 15 is inserted into the tunnel 14 and the hole 131 and has an bottom end exposing out of the hole 131. The signal feeder 15 has a semi-sphere shaped top end. The radiating metal plate 12 is electrically connected with the signal feeder 15 so as to act as a signal receiving and emitting end. The bottom end 152 of the signal feeder 15 is not electrically contacted with the grounding metal plate 13, but is electrically contacted with the circuit board 3. So the signals received by the antenna unit 1 can be transmitted to the circuit board 3.

The connecting unit 2 is made of metal material and has a top wall 21 electrically connecting with the grounding metal plate 13, a plurality of side walls 23 vertically extending downward from the edges of the top wall 21 and a plurality of protrusions 24 extending from the side walls 23. The shape of the top wall 21 of the connecting unit 2 coincides with the bottom surface of the base 11. An opening 22 is formed on the top wall 21 for passing though the bottom end 152 of the signal feeder 15, so that the bottom end 152 can electrically connect with the circuit board 3. The protrusions 24 are bendable or are electrically connected with the circuit board 3.

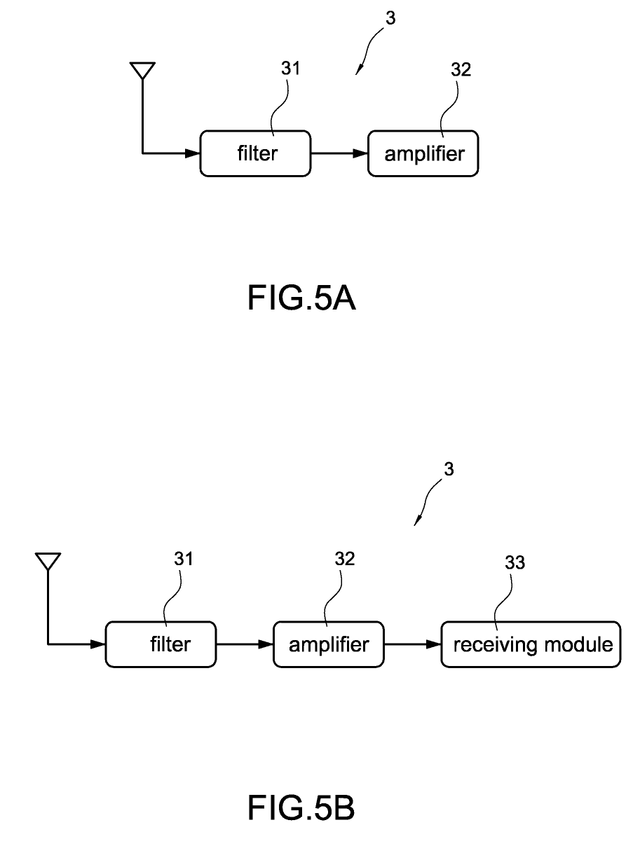

As shown in FIGS. 5A and 5B, the circuit board 3 has circuits including a filter 31 and an amplifier 32. The filter 31 is used for filtering out the noise from signals. Then, the signals are sent to the amplifier 32 and transmitted into the main board of the electronic device. A receiving module 33 (such as a GPS system circuit) can be arranged on the circuit board 3. After filtered out by the filter 31 and sent to the amplifier 32 for amplifying, the signals are sent to the receiving module 33 for further processing and sent to the main board of the electronic device for displaying.

The circuit board 3 also has a connecting hole portion 34 which has a first electric contact 35 disposed on the top or bottom surface of the circuit board 3. The bottom end 152 of the signal feeder 15 passes through the connecting hole portion 34 and electrically connected with the first electric contact 35. At least one second electric contact 37 is arranged on the bottom surface of the circuit board 3 for electrically connecting with the main board of the electronic device 3. In addition, at least one recess portion 36 is formed on the side of the circuit board 3. The recess portion 36 has a third electric contact 37 disposed on the bottom surface of the circuit board 3. The protrusions 24 are correspondingly inserted into the recess portions 36 and electrically connected with the third electric contacts 37. The connecting hole portion 34 has a blind hole or a through hole.

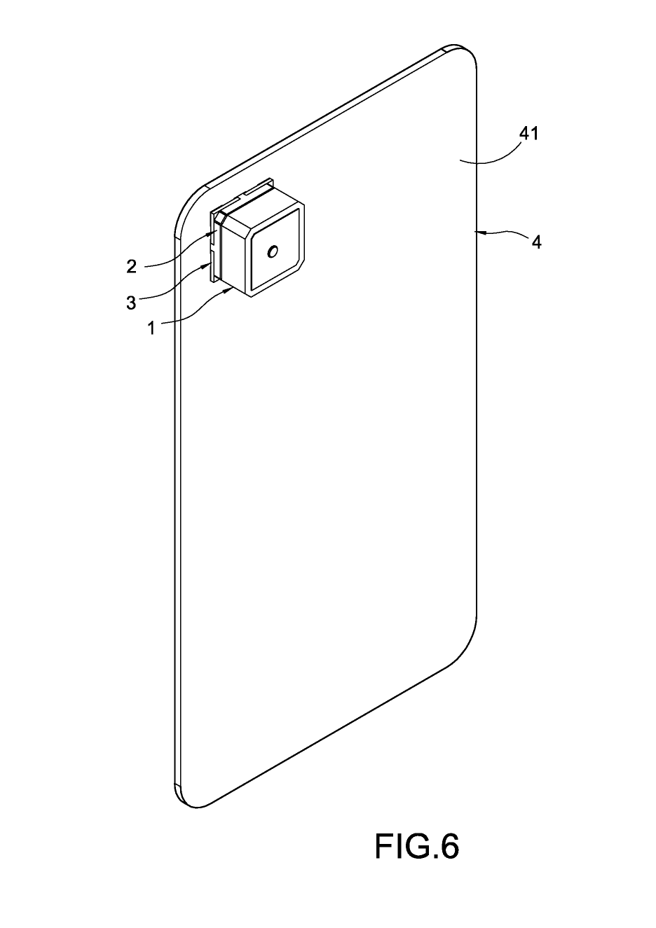

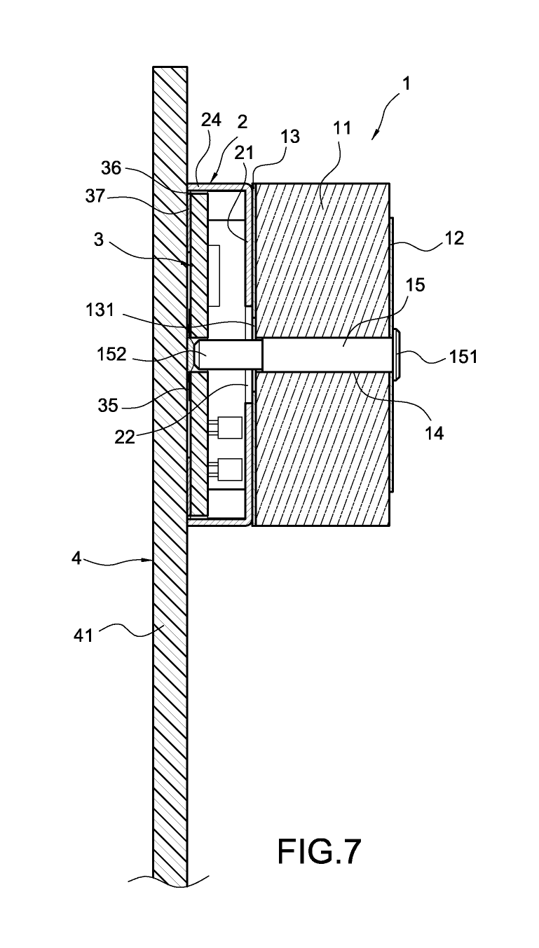

FIGS. 6 and 7 illustrate a side view of the antenna module connected with a main board of the electronic device. The connecting unit 2 is connected with the antenna unit 1 and the protrusions 24 on the side walls 23 are correspondingly inserted into the recess 36 of the circuit board 3 and electrically connected with the third electric contacts 37. The bottom end 152 of the signal feeder 15 of the antenna unit 1 passes through the opening 22 and is electrically connected with the first electric contact 35 of the connecting hole portion 34 of the circuit board 3.

The assembled antenna module is attached and electrically connected to the main board 41 of the electronic device 4 through the second electric contacts 38 on the bottom surface of the circuit board 3. With such a design on the antenna module, the dimensions and the length of the antenna module can be decreased. And the area of the main board covered by the antenna module can be decreased. Thus, the overall dimensions of the main board can be decreased. And the dimensions of the electronic device 4 can be consequently decreased.

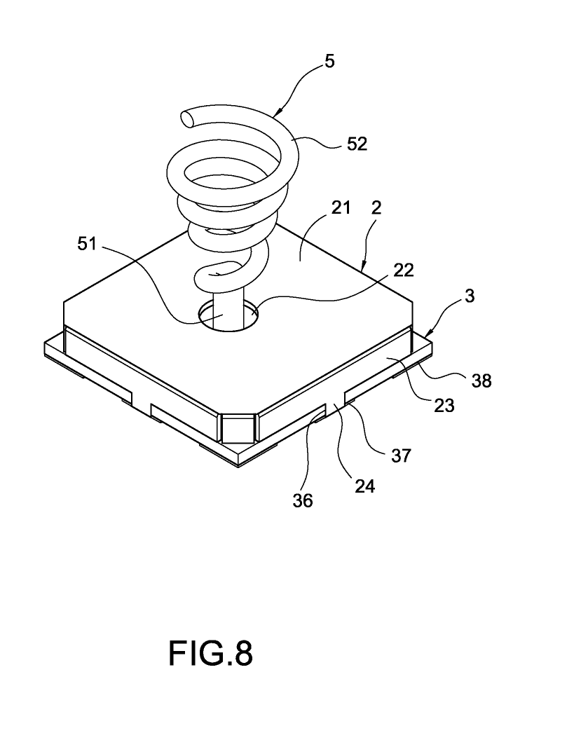

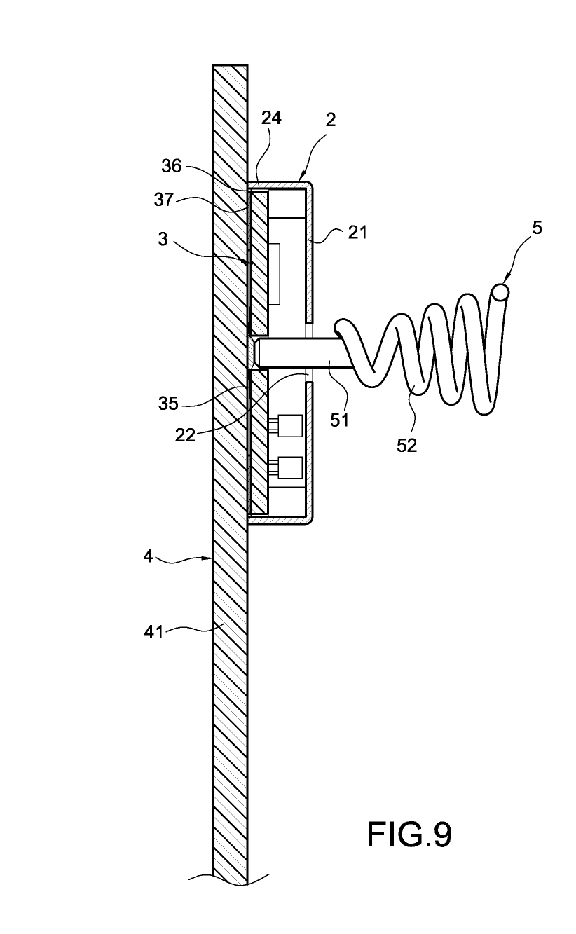

As FIG. 8 and FIG. 9 show, another surface mount device antenna module is disclosed. The antenna unit 5 is spiral-shaped helix monopole, which has a spiral-shaped rod portion 51. The rod portion 51 is a signal feeder of the first antenna unit 5 and has a spiral-shaped radiating metal portion 52. The rod portion 51 passes through the opening 22 and the connecting hole portion 34 of the circuit board 3 and electrically connects with the first electric contact 35.

After the radiating metal portion 52 of the antenna unit 5 receives signals, the signals will be transmitted through the rod portion 51 and to the circuit board 3. After processed by the circuit board 3, the signals will be transmitted to the main board 41 of the electronic device 4.

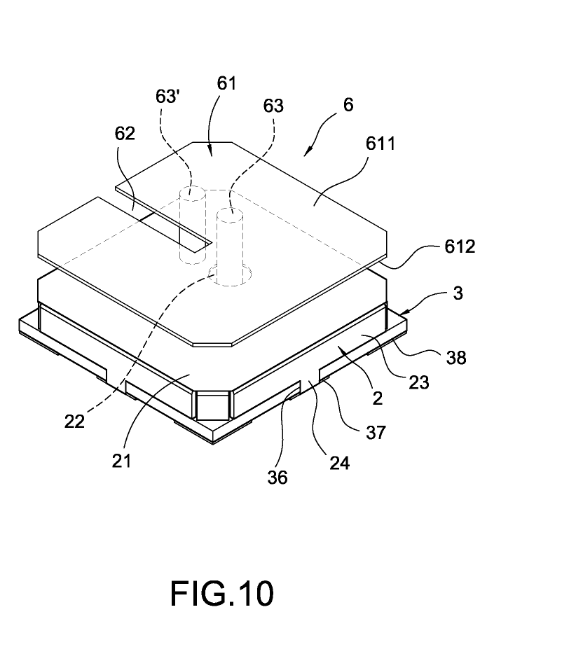

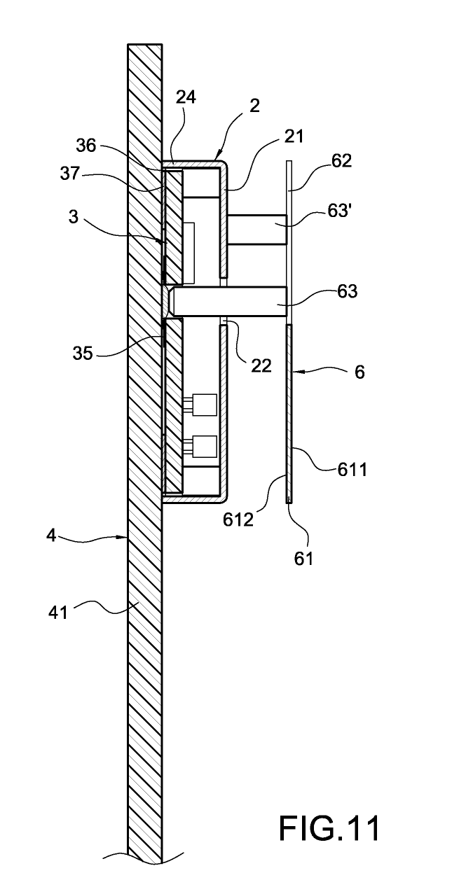

As FIG. 10 and FIG. 11 show, another antenna module is disclosed. The antenna unit 6 is an inverted-F antenna having PIFA structure. The antenna unit 6 has a radiating metal plate 61. The radiating metal plate 61 has a front surface 611 and a back surface 612 and a space 62. Two supporting portions 63, 63′ are connected to the back surface 612. One of the supporting portion 63 is a signal feeder, which passes through the opening 22 of the connecting unit 2 and the connecting hole portion 34 of the circuit board 3 and electrically connects with the first electric contact 35. The other supporting portion 63′ is for grounding. It can be electrically connected with the connecting unit 2. Alternatively, it can pass through the connecting unit 2 and electrically connects with the circuit board 3.

After the radiating metal plate 61 of the antenna unit 6 receives signals, the signals can be transmitted to the circuit board 3. Then, after processing by the circuit board 3, the signals can be transmitted to the main board 41 of the electronic device 4.

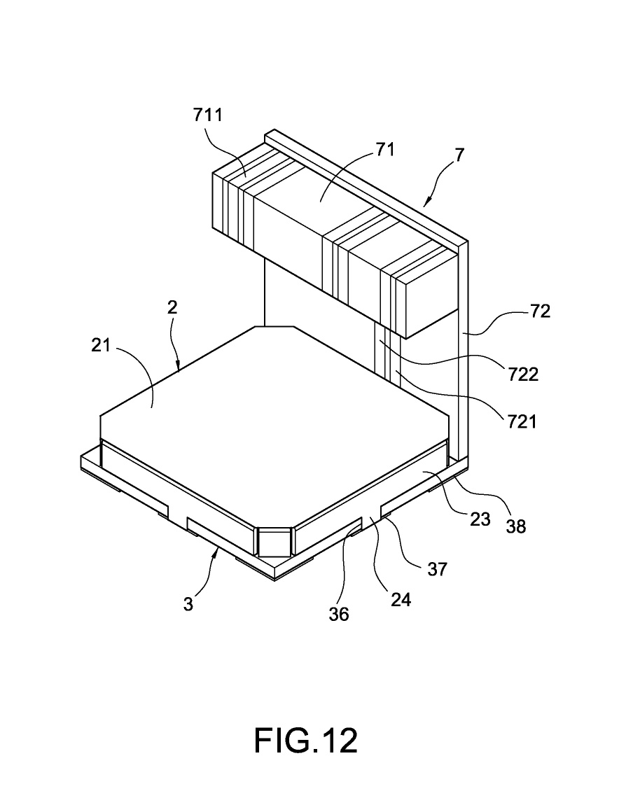

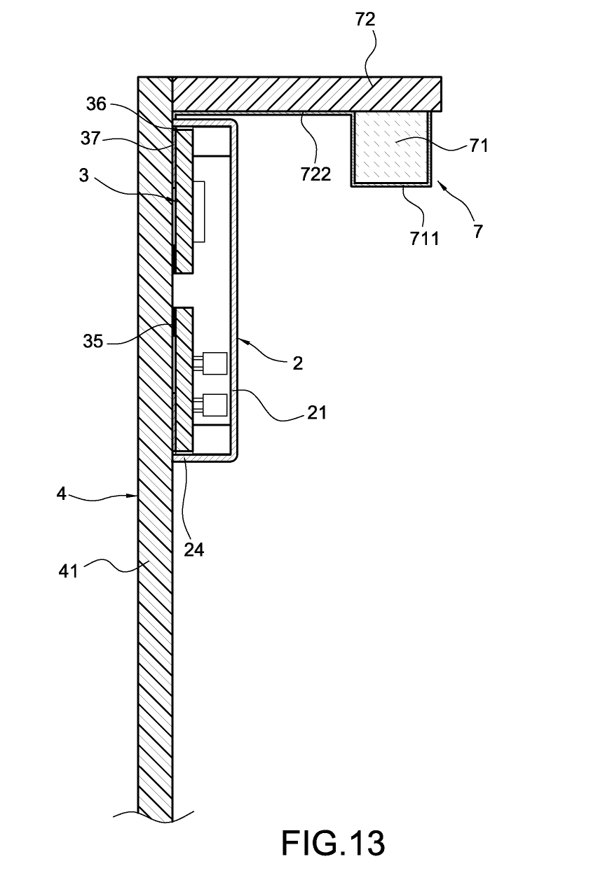

As FIG. 12 and FIG. 13 show, another surface mount device antenna module is disclosed. The antenna unit 7 is an attachable multiple band antenna. The antenna unit 7 has a transceiver 71 and a substrate 72. The transceiver 71 is made of ceramic material and can have various kinds of radiating pattern 711. The substrate 72 has a micro-stripe line 721 and a grounding line 722. The transceiver 71 is fixed on the substrate 72. The radiating pattern 71 is electrically connected with the micro-stripe line 721 and the grounding line 722. After the substrate 72 is combined with the transceiver 71, the substrate 72 is perpendicular to the circuit board 3 and electrically connects with the circuit board 3.

After the radiating pattern 711 of the transceiver 71 receives signals, the signals will be transmitted through the micro-stripe line 721 of the substrate 72 and to the circuit board 3. After processed by the circuit board 3, the signals will be transmitted to the main board 41 of the electronic device 4.

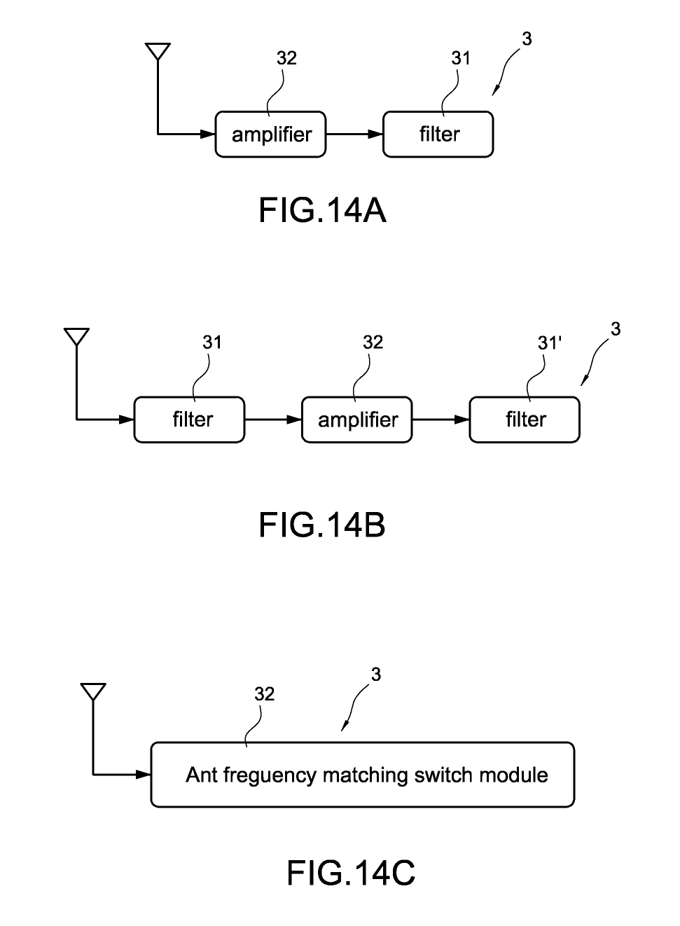

As FIG. 14A shows, another circuit diagram is disclosed. The difference between the circuits in FIG. 5A and this circuits is that after the signals received by the antenna module, the spiral-shaped helix monopole 5, the inverted F antenna 6 and the multiple band antenna 7, the signals will be amplified by the amplifier 32. Noise in the signals will be filtered out by the filter 32. Then the signal will be transmitted to the main board of the electronic device.

As FIG. 14B shows, another circuit diagram is disclosed. The difference between the circuits in FIG. 5A and this circuits is that another filter 31′ is further electrically connected to the amplifier 32. After the signals received by the antenna module, the spiral-shaped helix monopole 5, the inverted F antenna 6 and the multiple band antenna 7, the noise in the signals will be filtered out by the filter 31′. Then the signals will be amplified by the amplifier 32. Noise in the signals will be filtered out by the other filter 32. Then the signal without any noise will be transmitted to the main board of the electronic device.

As FIG. 14C shows, another circuit diagram is disclosed. The circuit board 3 further has a frequency matching switch module 39 for antenna. After the signals received by the antenna module, the spiral-shaped helix monopole 5, the inverted F antenna 6 and the attachable multiple band antenna 7, the signals will be processed by the frequency matching switch module 39 and then transmitted to the electronic device.

While the invention has been described by means of specific embodiments, numerous modifications and variations could be made thereto by those skilled in the art without departing from the scope and spirit of the invention set forth in the claims.

What is claimed is:

1. A surface mount device antenna module, for electrically connecting to the surface of a main board of an electronic device, the antenna module comprising:
an antenna unit having a base, a radiating metal plate arranged on the top surface of the base, a grounding metal plate arranged on the bottom surface of the base and a signal feeder, a tunnel being formed through the base and the radiating metal plate, a hole being formed on the grounding metal plate and connecting with the tunnel, the signal feeder being inserted into the tunnel and the hole and having an bottom end exposing out of the hole;
a connecting unit having a top wall electrically connecting with the grounding metal plate and a plurality of side walls vertically extending downward from the edges of the top wall, an opening being formed on the top wall for passing though the bottom end of the signal feeder, a plurality of protrusions extending from the side walls; and
a circuit board having a connecting hole portion which has a first electric contact disposed on the top or bottom surface of the circuit board, the bottom end of the signal feeder inserted into the connecting hole portion and electrically connected with the first electric contact, at least one second electric contact arranged on the bottom surface of the circuit board and electrically connected to the main board.

2. The antenna module as claim 1, wherein the base is a rectangular plate made of ceramic material.

3. The antenna module as claim 2, wherein the signal feeder is of T-shape and is used for feeding signals.

4. The antenna module as claim 3, wherein the signal feeder has a semi-sphere shaped top end.

5. The antenna module as claim 1, wherein the connecting unit is made of metal material.

6. The antenna module as claim 5, wherein the shape of the top wall of the connecting unit coincides with the bottom surface of the base.

7. The antenna module as claim 6, wherein the protrusions are bendable or are electrically connected with the circuit board.

8. The antenna module as claim 7, wherein the circuit board has circuits including a filter and an amplifier.

9. The antenna module as claim 7, wherein the circuit board has circuits including a filter, an amplifier and a receiving module.

10. The antenna module as claim 9, wherein the receiving module is a GPS system circuit.

11. The antenna module as claim 7, wherein at least one recess portion is formed on the side of the circuit board, and the recess portion has a third electric contact disposed on the bottom surface of the circuit board.

12. The antenna module as claim 1, wherein the connecting hole portion has a blind hole or a through hole.

13. A surface mount device antenna module, for electrically connecting to the surface of a main board of an electronic device, the antenna module comprising:
an antenna unit having a rod portion, a spiral-shaped radiating metal portion connected to the rod portion,
a connecting unit having a top wall electrically connecting with the grounding metal plate and a plurality of side walls vertically extending downward from the edges of the top wall, an opening being formed on the top wall for passing though the rod portion, a plurality of protrusions extending from the side walls; and
a circuit board having a connecting hole portion which has a first electric contact disposed on the top or bottom surface of the circuit board, the rod portion passing through the connecting hole portion and electrically connected with the first electric contact, at least one second electric contact arranged on the bottom surface of the circuit board and electrically connected to the main board.

14. The antenna module as claim 13, wherein the connecting unit is made of metal material.

15. The antenna module as claim 14, wherein the protrusions are bendable or are electrically connected with the circuit board, and at least one recess portion is formed on the side of the circuit board, and the recess portion has a third electric contact disposed on the bottom surface of the circuit board.

16. The antenna module as claim 15, wherein the circuit board has circuits including a filter and an amplifier.

17. The antenna module as claim 15, wherein the circuit board has circuits including a filter, an amplifier and a receiving module.

18. The antenna module as claim 17, wherein the receiving module is a GPS system circuit.

19. The antenna module as claim 15, wherein the circuit board has circuits including two filters and an amplifier.

20. The antenna module as claim 15, wherein he circuit board has circuits further including a frequency matching switch module.

21. The antenna module as claim 13, wherein the connecting hole portion has a blind hole or a through hole.

22. The antenna module as claim 21, wherein the antenna unit is a monopole antenna.

23. A surface mount device antenna module, for electrically connecting to the surface of a main board of an electronic device, the antenna module comprising:
an antenna unit having a radiating metal plate, the radiating metal plate having a front surface, a back surface and a space, two supporting portions connected to the back surface, one of the supporting portion being a signal feeder, the other supporting portion being for grounding;
a connecting unit having a top wall, a plurality of side walls vertically extending downward from the edges of the top wall, an opening being formed on the top wall for passing though one of the supporting portion, a plurality of protrusions extending from the side walls; and
a circuit board having a connecting hole portion which has a first electric contact disposed on the top or bottom surface of the circuit board, one of the supporting portion passing through the connecting hole portion and electrically connected with the first electric contact, at least one second electric contact arranged on the bottom surface of the circuit board and electrically connected to the main board.

24. The antenna module as claim 23, wherein the connecting unit is made of metal material.

25. The antenna module as claim 24, wherein the shape of the top wall of the connecting unit coincides with the bottom surface of the base.

26. The antenna module as claim 24, wherein the protrusions are bendable or are electrically connected with the circuit board, and at least one recess portion is formed on the side of the circuit board, and the recess portion has a third electric contact disposed on the bottom surface of the circuit board.

27. The antenna module as claim 26, wherein the circuit board has circuits including a filter and an amplifier.

28. The antenna module as claim 26, wherein the circuit board has circuits including a filter, an amplifier and a receiving module.

29. The antenna module as claim 28, wherein the receiving module is a GPS system circuit.

30. The antenna module as claim 26, wherein the circuit board has circuits including two filters and an amplifier.

31. The antenna module as claim 26, wherein he circuit board has circuits further including a frequency matching switch module.

32. The antenna module as claim 23, wherein the connecting hole portion has a blind hole or a through hole.

33. The antenna module as claim 32, wherein the supporting portion for grounding is electrically connected to the connecting unit or passes through the connecting unit and electrically connects to the circuit board.

34. A surface mount device antenna module, for electrically connecting to the surface of a main board of an electronic device, the antenna module comprising:
an antenna unit having a transceiver and a substrate, the transceiver having a radiating pattern, the substrate having a micro-stripe line and a grounding line, the transceiver being fixed on the substrate, the radiating pattern being electrically connected to the micro-stripe line and the grounding line;
a connecting unit having a top wall, a plurality of side walls vertically extending downward from the edges of the top wall, an opening being formed on the top wall for passing though one of the supporting portion, a plurality of protrusions extending from the side walls; and
a circuit board being perpendicular to the substrate and electrically connected to the substrate.

35. The antenna module as claim 34, wherein the transceiver is made of ceramic material.

36. The antenna module as claim 35, wherein the radiating pattern has various kinds of shapes.

37. The antenna module as claim 36, wherein the connecting unit is made of metal material.

38. The antenna module as claim 37, wherein the protrusions are bendable or are electrically connected with the circuit board, and at least one recess portion is formed on the side of the circuit board, and the recess portion has a third electric contact disposed on the bottom surface of the circuit board.

39. The antenna module as claim 38, wherein the circuit board has circuits including a filter and an amplifier.

40. The antenna module as claim 38, wherein the circuit board has circuits including a filter, an amplifier and a receiving module.

41. The antenna module as claim 40, wherein the receiving module is a GPS system circuit.

42. The antenna module as claim 38, wherein the circuit board has circuits including two filters and an amplifier.

43. The antenna module as claim 38, wherein he circuit board has circuits further including a frequency matching switch module.

44. The antenna module as claim 34, wherein the connecting hole portion has a blind hole or a through hole.
